(19) United States
(12) Patent Application Publication
(10) Pub. No.: US 2012/0117365 A1
(43) Pub. Date: May 10, 2012

(54) FIRMWARE UPDATE METHOD AND SYSTEM FOR MICRO-CONTROLLER UNIT IN POWER SUPPLY UNIT

(75) Inventors: Grothgla Navy, Amphur Muang (TH); Chantamoongkoon Preechapon, Amphur Muang (TH)

(73) Assignee: DELTA ELECTRONICS (THAILAND) PUBLIC CO., LTD., Samutprakarn (TH)

(21) Appl. No.: 12/941,691

(22) Filed: Nov. 8, 2010

(51) Int. Cl. G06F 9/00

(52) U.S. Cl. 713/2

(57) ABSTRACT

Disclosed is a firmware update system for a micro-controller unit in a power supply unit. The micro-controller unit includes a central processing unit and a flash memory connected to the central processing unit. The flash memory includes a boot program sector, a main program sector, and a temporary data sector, where the boot program sector contains a boot program and the main program sector contains a main program to be executed by the central processing unit under a normal operating mode, and the temporary data sector is set to contain a downloaded firmware code to be copied to the main program sector to replace the main program, thereby updating the flash memory. The downloaded firmware code contains a sector checksum value and a firmware signature for allowing the boot program to validate if the downloaded firmware code is valid and authentic, and the boot program sector and the main program sector are accessed by a virtual address.

### FIELD OF THE INVENTION

The invention is related to a firmware update method and system, and more particularly to a firmware update method and system for a micro-controller unit in a power supply unit.

### BACKGROUND OF THE INVENTION

FIG. 1 represents a micro-controller unit (MCU) for use in a power supply unit. In FIG. 1, a micro-controller unit 100 includes a central processing unit (CPU) 110, a random access memory (RAM) 111, a programming port 112, a flash memory 113, an I/O port 114, an oscillator 115, and a peripheral module 116. The CPU 110 handles the communications between the MCU 100 and external devices (not shown) and processes the data received from or sent through the I/O port 114. The random access memory 111 is configured to save the temporary data generated during the operating phase of the CPU 110. The flash memory 113 is configured to store the firmware codes for being executed by the CPU 110. The programming port 112 is a data programming interface for allowing a flash programming tool (not shown) to update the flash memory 113. The programming port 112 can be, for example, serial programming interface (SPI) port or in-circuit communication (ICC) port. The I/O 114 port is configured to receive data and commands from external devices and transmit data and commands to external devices. The oscillator 115 is configured to generate pulse signals as the clock signals to enable the operations of the CPU 110. The peripheral module 116 is connected to peripheral devices within the power supply unit. The peripheral module 116 can be I²C controller, UART controller, TCP/IP controller, USB controller, IEEE 1394 controller, or PWM controller.

FIG. 2 shows an example of performing firmware update to the micro-controller unit 100 of a power supply unit shown in FIG. 1 by a specific programming tool 200. It is to be noted that similar circuit elements are labeled with the same reference numerals throughout the specification. As shown in FIG. 2, a specific programming tool 200 is connected to the micro-controller unit 100 through the programming port 112 for programming the flash memory 113. FIG. 3 shows an example of performing firmware update to the micro-controller unit 100 of a power supply unit of FIG. 1 by an in-application programming system. As shown in FIG. 3, the micro-controller unit 100 is connected to a host device 300 through a peripheral interface 302. The peripheral interface 302 is exemplified with an I²C port and the peripheral module 116 is illustrated as an I²C controller accordingly. Further, FIG. 4 illustrates the conceptual representation of firmware update system of FIG. 3. The host device 300 of FIG. 3 can be implemented by a web application 402 and the peripheral port 302 can be implemented by an Ethernet connector, as shown in FIG. 4. The web application 402 is configured to send firmware codes through the Ethernet connector 404 to the power supply unit 400, as shown in FIG. 4. In FIG. 4, four power supply units 400 are cascaded on a backplane (not shown) for supplying power to electronic devices. The micro-controller unit 100 of FIG. 1 is placed in the power supply unit 400 of FIG. 4.

FIG. 5 shows the mapping chart of the flash memory 113 of FIG. 1 according to the prior art. The memory space of the flash memory 113 is generally divided into three sectors. The first sector 502 is also known as a factory program and boot program sector and is used to store a factory default program and a boot program, and is protected from being updated through an in-application programming system of FIG. 3. The factory program and boot program sector 502 can only be programmed by specific programming tool 200 of FIG. 2. The second sector 504 is also known as a main program sector and is used to store a main program which is running under a normal operating mode. When the firmware code is downloaded to the flash memory 113, the central processing unit 110 is operated in this sector. When the firmware code has been downloaded and is ready to be copied, the execution of the CPU 110 jumps to the factory program and boot program sector 502. The third sector 506 is also known as a temporary data sector and is used to temporarily store the downloaded firmware codes. The CPU 110 will not execute code in this sector.

FIG. 6 shows the mapping chart of the temporary data sector 506 of the flash memory 113 of FIG. 1 according to the prior art. In FIG. 6, the temporary data 506 (downloaded firmware code) includes a checksum 604 representing a logic sum of the downloaded firmware code, and a firmware image password 606 representing the accessing password of the downloaded firmware code. After receiving the downloaded firmware code, the CPU 110 will check if the checksum 604 is correct and verify if the firmware image password 606 is correct. If either the checksum checking process or the password verifying process is failed, the CPU 110 will ignore the downloaded firmware code and execute the original firmware code contained in the main program sector 504 of the flash memory 113.

### SUMMARY OF THE INVENTION

It is therefore an aspect of the invention to provide a firmware update method and system for a micro-controller unit in a power supply unit for enhancing the security of the downloaded firmware code and downsizing the boot program sector.

It is therefore another aspect of the invention to provide a firmware update method and system for a micro-controller unit in a power supply unit for standardize the coding process of the firmware code and increase the compatibility of the firmware codes with a variety of flash memory products.

According to one embodiment of the invention a firmware update system for a micro-controller unit in a power supply unit is proposed. The micro-controller unit includes a central processing unit and a flash memory connected to the central processing unit. The flash memory includes a boot program sector, a main program sector, and a temporary data sector, where the boot program sector contains a boot program and the main program sector contains a main program to be executed by the central processing unit under a normal operating mode, and the temporary data sector is set to contain a downloaded firmware code to be copied to the main program sector to replace the main program, thereby updating the flash memory. The downloaded firmware code contains a sector checksum and a firmware signature for allowing the boot program to verify if the downloaded firmware code is valid and authentic, and the boot program sector and the main program sector are addressed by a virtual address.

According to another embodiment of the invention a firmware update system for a micro-controller unit in a power supply unit is proposed. A firmware update system includes a central processing unit, and a flash memory connected to the central processing unit and having a boot program sector, a main program sector, and a temporary data sector, wherein the boot program sector contains a boot program and the main program sector contains a main program to be executed by the central processing unit under a normal operating mode, and the temporary data sector is configured to contain a downloaded firmware code to be copied to the main program sector to replace the main program, thereby updating the flash memory, wherein the downloaded firmware code contains a sector checksum and a firmware signature for allowing the boot program to verify if the downloaded firmware code is valid and authentic.

The sector checksum is a CRC-16 checksum. The firmware signature is an ASCII code having 8-16 bytes. The boot program is configured to be executed by the central processing unit to copy the downloaded firmware code to the main program sector. The boot program sector and the main program sector are accessed by a virtual address.

According to one embodiment of the invention a firmware update method for updating a flash memory is proposed, wherein the flash memory includes a boot program sector, a main program sector, and a temporary data sector, and wherein the boot program sector contains a boot program and the main program sector contains a main program to be executed under a normal operating mode, and the temporary data sector is set to contain a downloaded firmware code. The method includes the steps of: (I) activating the boot program with a flash copy function; (II) determining if a sector checksum of the downloaded firmware code is valid or a firmware signature of the downloaded firmware code is authentic; and (III) if the sector checksum of the downloaded firmware code is valid and the firmware signature of the downloaded firmware code is authentic, copying the downloaded firmware code to the main program sector to replace the main program, thereby updating the flash memory.

Now the foregoing and other features and advantages of the present invention will be best understood through the following descriptions with reference to the accompanying drawings, wherein:

### BRIEF DESCRIPTION OF THE DRAWINGS

FIG. 1 represents a micro-controller unit (MCU) for use in a power supply unit;

FIG. 2 shows an example of performing firmware update to the micro-controller unit of a power supply unit shown in FIG. 1 by a specific programming tool;

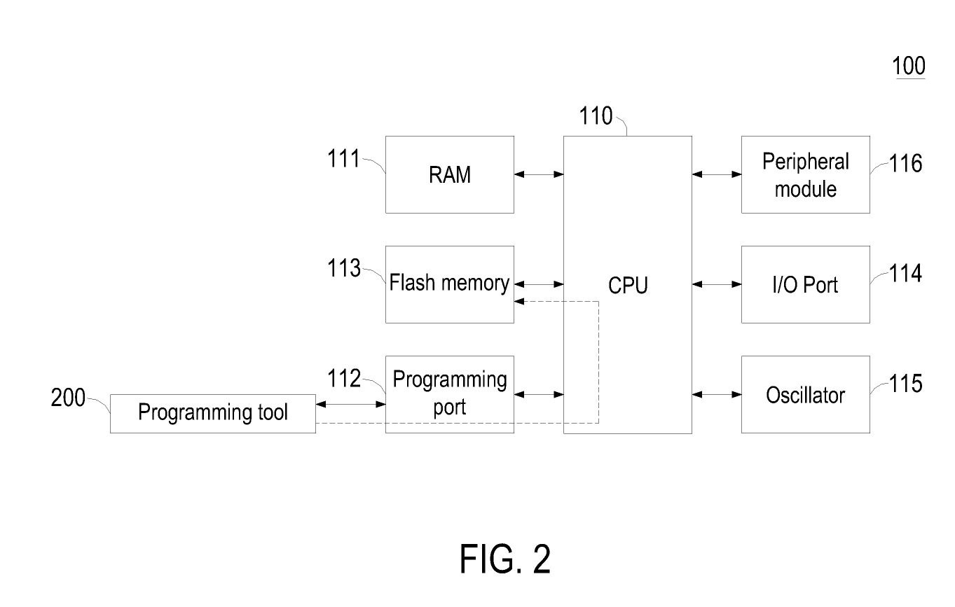

FIG. 3 shows an example of performing firmware update to the micro-controller unit of a power supply unit shown in FIG. 1 by an in-application programming system;

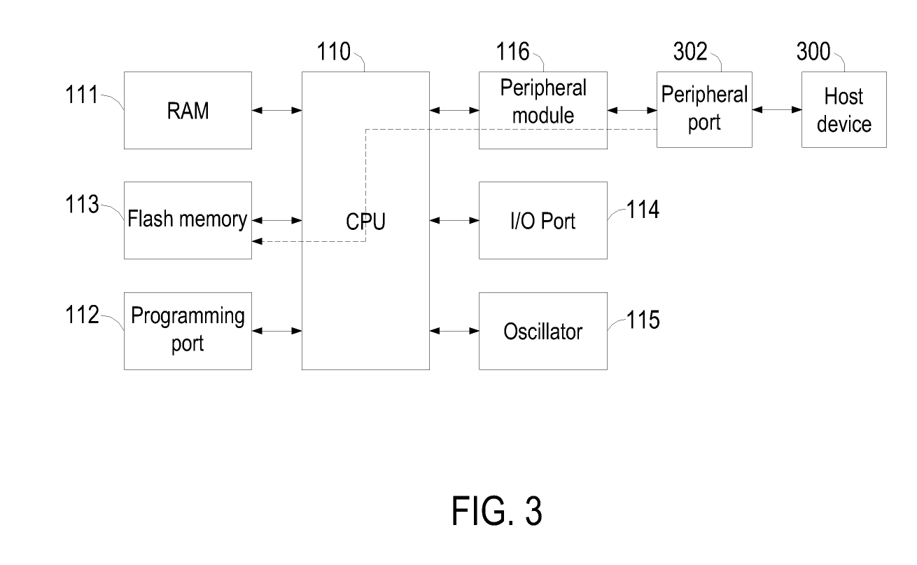

FIG. 4 shows the conceptual representation of firmware update system of FIG. 3;

FIG. 5 shows the mapping chart of the flash memory of FIG. 1 according to the prior art;

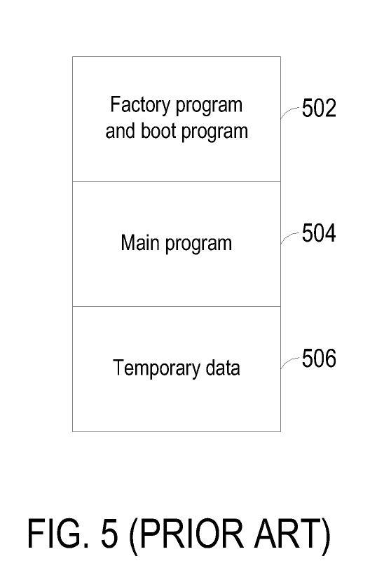

FIG. 6 shows the mapping chart of the third sector of the flash memory of FIG. 1 according to the prior art;

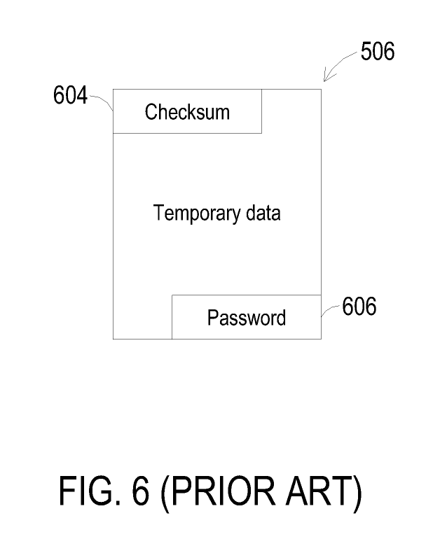

FIG. 7 is a mapping chart of the flash memory of the micro-controller unit of FIG. 1 according to the invention;

FIG. 8 shows the mapping chart of the temporary data sector of the flash memory of FIG. 1 according to one embodiment of the invention;

FIG. 9(A) is a flowchart illustrating the start-up process of the micro-controller unit according to one embodiment of the invention; and

FIG. 9(B) is a flowchart illustrating the flash copy process according to one embodiment of the invention.

### DETAILED DESCRIPTION OF THE PREFERRED EMBODIMENT

Several preferred embodiments embodying the features and advantages of the invention will be expounded in following paragraphs of descriptions. It is to be realized that the present invention is allowed to have various modification in different respects, all of which are without departing from the scope of the present invention, and the description herein and the drawings are to be taken as illustrative in nature, but not to be taken as limitative.

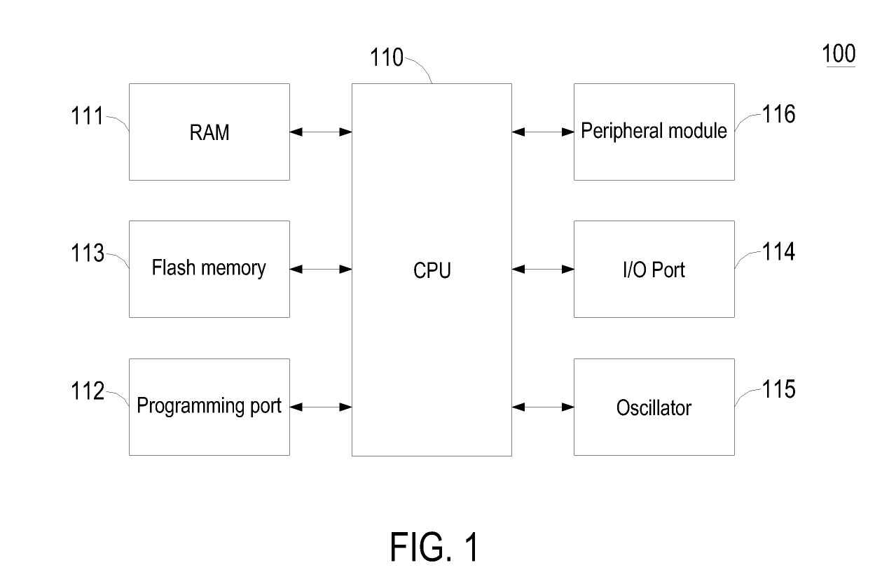

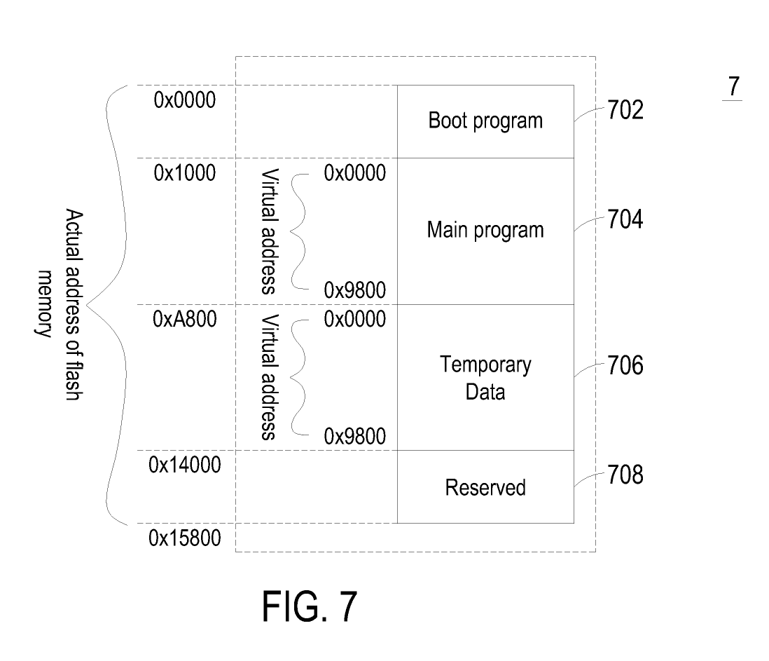

The present invention provides a firmware update system for a micro-controller unit in a power supply unit. The firmware update system includes a central processing unit, and a flash memory connected to the central processing unit and having a boot program sector, a main program sector, and a temporary data sector, wherein the boot program sector contains a boot program and the main program sector contains a main program to be executed by the central processing unit under a normal operating mode, and the temporary data sector is configured to contain a downloaded firmware code to be copied to the main program sector to replace the main program, thereby updating the flash memory. Please refer to FIG. 7 which is a mapping chart of the flash memory 7 of the micro-controller unit according to the one embodiment of invention, wherein the micro-controller unit is similar to that shown in FIG. 1 so that the detailed description of the micro-controller unit is omitted. In FIG. 7, the memory space of the flash memory 7 according to the invention is generally divided into four sectors. The first sector 702 is also known as a boot program sector with its actual address ranging from 0x0000 to 0x0FFF. The boot program sector 702 is used to store a boot program that is not to be executed by the central processing unit 110 under the normal operating mode. The boot program 702 contains the functions of initiating the start-up of the micro-controller unit 100, copying the downloaded firmware codes contained in the temporary data sector 706 to the main program sector 704, retrying the copy operation in case of the failure of the last copy operation, and downloading the firmware code to the temporary data sector 706. It is to be noted that the boot program sector 702 can not be updated by an in-application programming system, but can be updated by a specific programming tool. The memory space of the flash memory 7 according to the invention further includes a second sector 704 with its actual address ranging from 0x1000 to 0xA7FF. The second sector 704 is also known as a main program sector for storing the firmware code that is running under the normal operating mode. The memory space of the flash memory 7 according to the invention further includes a third sector 706 with its actual address ranging from 0xA8000 to 0x13FFF. The third sector is also known as a temporary data sector for storing the downloaded firmware codes. The memory space of the flash memory 7 according to the invention further includes a fourth sector 708 with its actual address ranging from 0x14000 to 0x157FF. The fourth sector 708 is also known as a reserved sector which is unused and reserved for future use.

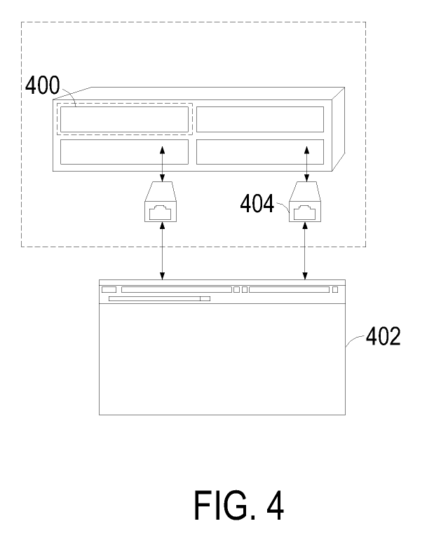

However, it is to be noted that the invention applies a virtual address remapping mechanism to address each sector for allowing the micro-controller unit to access the sectors by a virtual address. For example, the main program sector 704 is remapped to a virtual address ranging from 0x0000 to 0x9800, and the temporary data sector 706 is remapped to a virtual address ranging from 0x0000 to 0x9800. In this manner, each of the second sector 704 and the third sector 706 will be initiated with the same starting address of 0x0000. Hence, the programmer does not need to care about the real actual address of the firmware codes that are about to be executed, but only needs to know the spatial interval between the firmware codes that are to be executed and the starting point of the sector. This can standardize the firmware coding process in a uniform way and render the firmware codes reusable in any kind of flash memory despite the difference of the sector size. This is because the virtual address always starts at 0x0000. Further, the boot program sector 702 according to the invention will be downsized and compared to the factory program and boot program sector 402 of FIG. 4. This is because the boot program in the boot program sector 702 can retry copying the downloaded firmware codes to the main program sector 704 in case of the failure of copying the downloaded firmware codes to the main program sector 704. Therefore, the factory program is eliminated from the first sector of the flash memory 7 according to the invention due to such failsafe measure of copy retrying function.

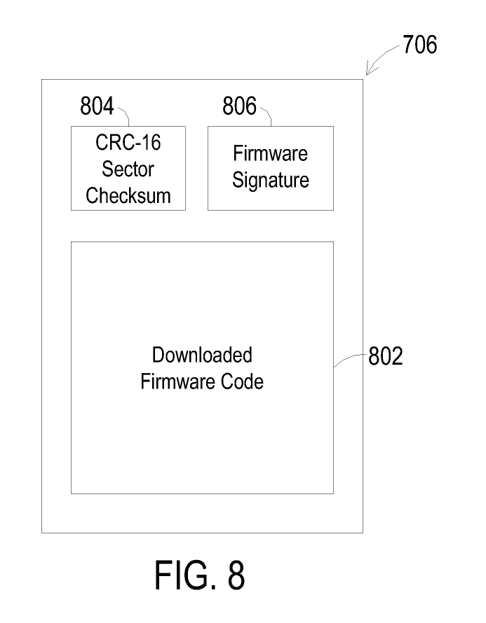

FIG. 8 shows the mapping chart of the temporary data sector 706 of the flash memory 7 of the micro-controller unit according to one embodiment of the invention. In FIG. 8, the temporary data sector 706 contains a downloaded firmware code 802, a CRC-16 sector checksum 804, and a firmware signature 806. The CRC-16 sector checksum 804 and the firmware signature 806 constitute a firmware header of 32 bytes, in which the firmware signature 806 is an 8-16 byte ASCII code. The CRC-16 sector checksum 804 is used to validate if the downloaded firmware code 802 is valid or corrupted before the downloaded firmware code 802 is copied to the main program sector 704. The CRC-16 sector checksum 804 is generally generated by a software tool. Also, the firmware signature 806 is used to authenticate if the downloaded firmware code 802 to be copied is matched to hardware revision/model of the micro-controller unit 100. Therefore, the invention provides a more efficient and reliable measure to verify the validity and authenticity of the downloaded firmware code by using a CRC-16 sector checksum 804 and a vendor-specific ASCII code firmware signature 806 to improve the security of downloaded firmware codes.

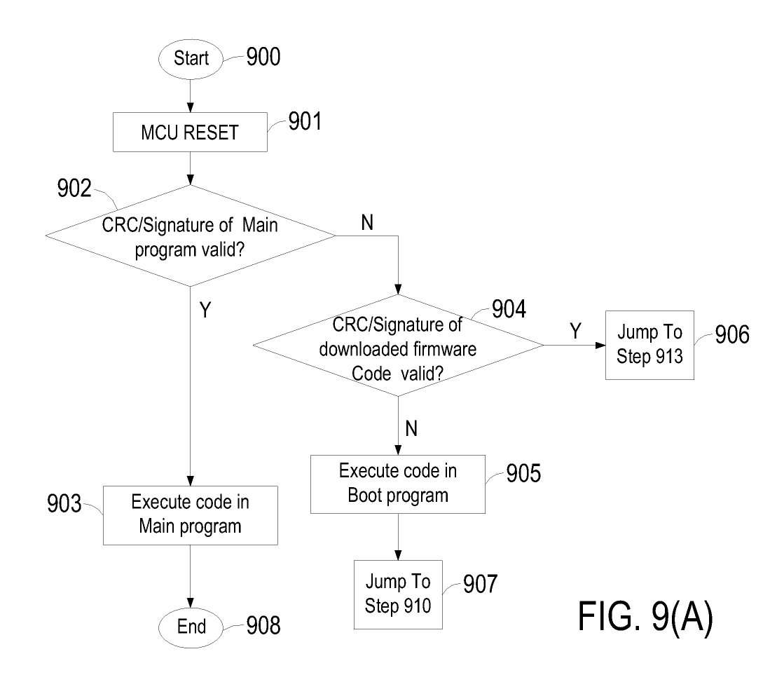

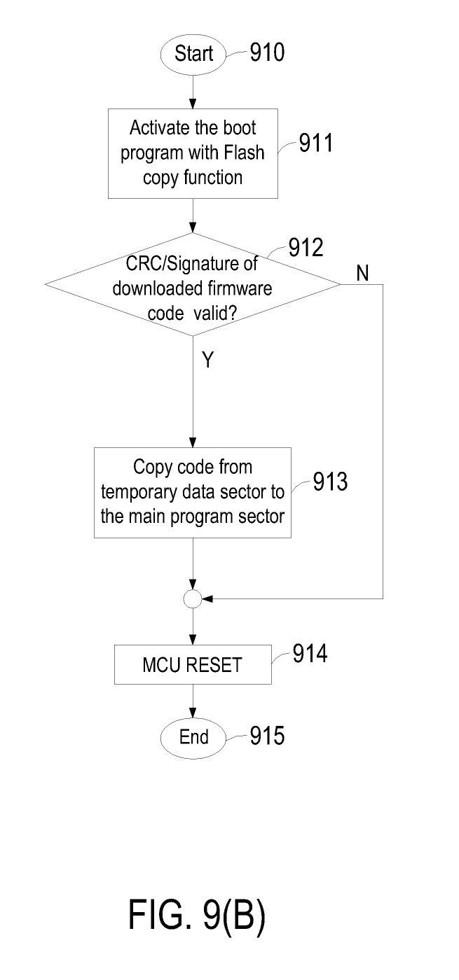

FIG. 9(A) is a flowchart illustrating the start-up process of the micro-controller unit according to one embodiment of the invention. The process begins with step 900. Step 901 represents that the micro-controller unit of the invention is reset. Step 902 represents that the boot program 702 of the flash memory 7 will determine if the CRC-16 checksum and the firmware signature appended to the main program 704 are valid. If the CRC checksum and the firmware signature appended to the main program 704 are valid, the process continues with the step 903 by executing the firmware code contained in the main program 704. If CRC-16 checksum or the firmware signature appended to the main program in the second sector 704 is invalid or unauthentic, it indicates that the operation of copying the downloaded firmware code 802 to the main program 704 is failed in the last attempt due to loss of power. Therefore, the boot program 702 will start a copy retrial process to retry copying the downloaded firmware code to the main program sector 704. As a result, the process continues with step 904 by determining if the CRC checksum and the firmware signature appended to the downloaded firmware code 802 is valid. If the boot program determines that the CRC-16 checksum and the firmware signature appended to the downloaded firmware code 802 is valid, the process continues with the step 906 by jumping the process to step 913 which is a step to be described in the flash copy process indicated in FIG. 9(B). Otherwise, if the boot program determines that the CRC-16 checksum or the firmware signature appended to the downloaded firmware code 802 is invalid or unauthentic, the process continues with the step 905 by executing the codes of the boot program 702. Afterwards, the process continues with the step 907 by jumping the execution to the step 910 indicated as the beginning step of FIG. 9(B). The process ends up with step 908.

FIG. 9(B) shows the flash copy process carried out by the boot program 702 according to the invention. The process begins with step 910. Step 911 represents that the boot program activates the flash copy function. Step 912 represents that the boot program determines if the CRC-16 checksum or the firmware signature appended to the downloaded firmware code 802 is valid. If the CRC-16 checksum or the firmware signature appended to the downloaded firmware code 802 is invalid, the micro-controller unit 100 is reset at step 914. If the CRC-16 checksum and the firmware signature appended to the downloaded firmware code 802 is valid, the process continues with the step 913 by copying the downloaded firmware code 802 to the main program sector 704 to replace the main program 704, thereby accomplishing the firmware update process. Afterwards, the process continues with the step 914 by resetting the micro-controller unit 100. The whole process ends up with step 915.

In sum, the invention is advantageous over the prior in terms of the following aspects:

1. Because the addressing mechanism of the memory space of the flash memory is switched to a virtual addressing mechanism, each sector is accessed by a virtual address instead of actual address. Therefore, the programmer can be benefited due to the standardization of the firmware coding process, and the firmware code can be applied to a wide variety of flash program products.

2. The boot program sector is downsized due to the elimination of the factory program. The boot program of the invention is provided with a flash copy function that allows the copy process to be retried in case of the failure of copying the downloaded firmware code to the main program sector due to power blackout in the last attempt of copying process. Therefore, the boot program can incessantly retry the copying process to copy the downloaded firmware code into the main program sector until the copying process is successful. Thus, the factory program which is used as a failsafe measure for the unsuccessful coping process is unnecessary and can be removed from the boot program sector, thereby downsizing the boot program sector.

3. The boot program can retry the copying process for copying the downloaded firmware code to the main program sector until the copying process is successful.

4. A CRC-16 sector checksum and a firmware signature is appended to the firmware code. Therefore, the invention can detect the missing or misplaced bytes of the firmware code. In this way, the invention reinforces the security of the firmware code during the firmware update process.

While the present invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A firmware update system for a micro-controller unit in a power supply unit comprising:
a central processing unit; and
a flash memory connected to the central processing unit and having a boot program sector, a main program sector, and a temporary data sector, wherein the boot program sector contains a boot program and the main program sector contains a main program to be executed by the central processing unit under a normal operating mode, and the temporary data sector is configured to contain a downloaded firmware code to be copied to the main program sector to replace the main program, thereby updating the flash memory;
wherein the downloaded firmware code contains a sector checksum and a firmware signature for allowing the boot program to verify if the downloaded firmware code is valid and authentic.

2. The firmware update system according to claim 1, wherein the sector checksum is a CRC-16 checksum.

3. The firmware update system according to claim 1, wherein the firmware signature is an ASCII code having 8-16 bytes.

4. The firmware update system according to claim 1, wherein the boot program is configured to be executed by the central processing unit to copy the downloaded firmware code to the main program sector.

5. The firmware update system according to claim 1, wherein the boot program sector and the main program sector are accessed by a virtual address.

6. A firmware update system for a micro-controller unit in a power supply unit comprising:
a central processing unit; and
a flash memory connected to the central processing unit and having a boot program sector, a main program sector, and a temporary data sector, wherein the boot program sector contains a boot program and the main program sector contains a main program to be executed by the central processing unit under a normal operating mode, and the temporary data sector is configured to contain a downloaded firmware code to be copied to the main program sector to replace the main program, thereby updating the flash memory;
wherein the boot program sector and the main program sector are accessed by a virtual address.

7. The firmware update system according to claim 6, wherein the downloaded firmware code contains a sector checksum and a firmware signature for allowing the boot program to verify if the downloaded firmware code is valid and authentic.

8. The firmware update system according to claim 7, wherein the sector checksum is a CRC-16 checksum.

9. The firmware update system according to claim 7, wherein the firmware signature is an ASCII code having 8-16 bytes.

10. The firmware update system according to claim 7, wherein the boot program is configured to be executed by the central processing unit to copy the downloaded firmware code to the main program sector.

11. A firmware update method for updating a flash memory, wherein the flash memory includes a boot program sector, a main program sector, and a temporary data sector, and wherein the boot program sector contains a boot program and the main program sector contains a main program to be executed under a normal operating mode, and the temporary data sector is configured to contain a downloaded firmware code, the method comprising the steps of:
activating the boot program with a flash copy function;
determining if a sector checksum of the downloaded firmware code is valid and a firmware signature of the downloaded firmware code is authentic; and
if the sector checksum is valid and the firmware signature of the downloaded firmware code is authentic, copying the downloaded firmware code to the main program sector to replace the main program, thereby updating the flash memory.

12. The firmware update method for updating a flash memory according to claim 11, wherein before the step of activating the boot program with a flash copy function, the method further comprising the following steps of:
determining if a sector checksum of the main program is valid or a firmware signature of the main program is authentic; and
if the sector checksum of the main program is valid and the firmware signature of the main program is authentic, executing the main program.

13. The firmware update method for updating a flash memory according to claim 12, wherein before the step of activating the boot program with a flash copy function, the method further comprising the following steps of:
determining if a sector checksum of the main program is valid or a firmware signature of the main program is authentic; and
if the sector checksum of the main program is invalid or the firmware signature of the main program is unauthentic, determining if a sector checksum of the downloaded firmware code is valid and a firmware signature of the downloaded firmware code is authentic.

14. The firmware update method for updating a flash memory according to claim 13, wherein before the step of activating the boot program with a flash copy function, the method further comprising the following steps of:
if the a sector checksum of the downloaded firmware code is invalid or a firmware signature of the downloaded firmware code is unauthentic, executing the boot program.

15. The firmware update method for updating a flash memory according to claim 14, wherein before the step of activating the boot program with a flash copy function, the method further comprising the following steps of:
if the a sector checksum of the downloaded firmware code is valid and a firmware signature of the downloaded firmware code is authentic, copying the downloaded firmware code to the main program sector to replace the main program, thereby updating the flash memory.

16. The firmware update method for updating a flash memory according to claim 14, wherein after the step of executing the boot program, the step of activating the boot program with a flash copy function is executed.
